(19) United States
(12) Patent Application Publication
(10) Pub. No.: US 2024/0036150 A1
(43) Pub. Date: Feb. 1, 2024

(54) MULTIPLE CONFIGURATIONS FOR POSITIONING PROCEDURES

(71) Applicant: HUAWEI TECHNOLOGIES CO., LTD., Shenzhen (CN)

(72) Inventors: Maria FRESIA, Munich (DE); Taimoor ABBAS, Kista (SE); Kiseon RYU, Kista (SE); Gustaf CLAESON, Kista (SE)

(21) Appl. No.: 18/485,095

(22) Filed: Oct. 11, 2023

Related U.S. Application Data
(63) Continuation of application No. PCT/EP2021/059561, filed on Apr. 13, 2021.

(51) Int. Cl. G01S 5/02; H04W 64/00; H04L 5/00

(52) U.S. Cl. CPC G01S 5/0263; H04W 64/003; H04L 5/0048

(57) ABSTRACT

The present disclosure provides a mechanism enabling switching between different configuration for a positioning procedure to dynamically adapt the accuracy of the positioning procedure to the current requirements of client devices and/or environmental conditions. The switch may be initiated by a network node which can instruct a client device to deactivate positioning according to a first configuration and to activate positioning according to a second configuration. The network node can determine the second configuration based on e.g. position of client device, density of client devices, current position requirements per client device, network load, and/or available resources. Thereby, allowing the configuration for the positioning procedure to be adapted based on dynamic requirements on the positioning procedure.

### CROSS-REFERENCE TO RELATED APPLICATIONS

This application is a continuation of International Application No. PCT/EP2021/059561, filed on Apr. 13, 2021, the disclosure of which is hereby incorporated by reference in its entirety.

### TECHNICAL FIELD

The present disclosure relates to a network node and a client device for determining and exchanging configurations for positioning procedures to determine positioning information of the client device. Furthermore, the present disclosure also relates to corresponding methods and a computer program.

### BACKGROUND

3GPP (3rd Generation Partnership Project) has been developing solutions for positioning services based on the requirements in e.g. technical specifications (TSs), such as TS 22.261 and TS 22.186. Among the various use cases requiring accurate positioning are vehicle to anything (V2X), autonomous driving, industrial internet of things (IIoT) and public safety. The user equipment (UE) needs to support positioning procedures/methods in these and other use cases for in-coverage, partial coverage, and out-of-coverage scenarios.

For advanced use cases there is a high demand on accurate positioning of a UE. Relative positioning accuracy required between UEs could be as low as 0.1 m lateral, and 0.5 m longitudinal in different kind of environments with or without cellular coverage. Currently both network- and UE-based radio access technology (RAT) dependent methods are used for accurate position estimation.

### SUMMARY

An objective of embodiments of the present disclosure is to provide a solution which mitigates or solves the drawbacks and problems of conventional solutions.

The above and further objectives are solved by the subject matter of the independent claims. Further advantageous embodiments of the present disclosure can be found in the dependent claims.

According to a first aspect of the present disclosure, the above mentioned and other objectives are achieved with a network node for a communication system, the network node being configured to
determine a geographical position of a client device being configured to perform a positioning procedure according to a first configuration;
determine a set of system parameters associated with the client device based on the geographical position of the client device;
determine a second configuration for the positioning procedure based on the set of system parameters associated with the client device;
transmit a first message to the client device, the first message comprising an indication to perform the positioning procedure according to the second configuration; and
receive a second message from the client device, the second message indicating positioning information of the client device according to the second configuration.

A positioning procedure herein may also be denoted a positioning method or a positioning solution.

An advantage of the network node according to the first aspect is that the configuration of the positioning procedure can be dynamically tuned in order to adapt to different use cases and up-to-date system conditions per local geographical location. Thereby, improved resource utilization is provided.

In an embodiment of a network node according to the first aspect, the set of system parameters comprise a client device density of a geographical area associated with the geographical position and/or a positioning requirement associated with the geographical position.

An advantage with this embodiment is that the network node may adaptively determine the set of system parameters for the second configuration considering various use cases and different positioning requirement of the client device.

In an embodiment of a network node according to the first aspect, the second configuration comprises a reference signal indicating a configuration of a periodicity and/or a resource allocation.

An advantage with this embodiment is that it may reduce the signaling overhead for indicating the second configuration with only few updated parameters by omitting the parameters which are redundant to the first configuration.

In an embodiment of a network node according to the first aspect, the positioning procedure is a downlink positioning procedure and wherein the reference signal is a positioning reference signal.

An advantage with this embodiment is that it may provide the solution of which the downlink positioning procedure is backward compatible to the 3GPP standard.

In an embodiment of a network node according to the first aspect, the positioning procedure is an uplink positioning procedure and wherein the reference signal is a sounding reference signal.

An advantage with this embodiment is that it may provide the solution of which the uplink positioning procedure is backward compatible to the 3GPP standard.

In an embodiment of a network node according to the first aspect, the positioning procedure is a downlink positioning procedure and an uplink positioning procedure, and wherein the reference signal is a positioning reference signal in the downlink positioning procedure and a sounding reference signal in the uplink positioning procedure.

An advantage with this embodiment is that it may provide the solution of which the downlink positioning procedure and the uplink positioning procedure is backward compatible to the 3GPP standard.

In an embodiment of a network node according to the first aspect, the network node is a location management function, and wherein the first message and the second message are LTE positioning protocol messages.

An advantage with this embodiment is that it can provide a compatible solution to the specification in the 3GPP standard for simplified implementation.

According to a second aspect of the present disclosure, the above mentioned and other objectives are achieved with a client device for a communication system, the client device being configured to
perform a positioning procedure according to a first configuration;
receive a first message from a network node, the first message comprising an indication to perform the positioning procedure according to a second configuration;
perform the positioning procedure according to the second configuration to obtain positioning information of the client device; and
transmit a second message to the network node, the second message indicating the positioning information of the client device according to the second configuration.

An advantage of the client device according to the second aspect is that the configuration of the positioning procedure can be dynamically tuned in order to adapt to different use cases and up-to-date system conditions per local geographical location. Thereby, improved resource utilization is provided.

In an embodiment of a client device according to the second aspect, the second configuration comprises a reference signal indicating a configuration of a periodicity and/or a resource allocation.

An advantage with this embodiment is that it may reduce the signaling overhead for indicating the second configuration with only few updated parameters by omitting the parameters which are redundant to the first configuration.

In an embodiment of a client device according to the second aspect, the positioning procedure is a downlink positioning procedure and the reference signal is a positioning reference signal; and the client device is configured to
receive the positioning reference signal in the downlink according to the second configuration.

An advantage with this embodiment is that it may provide the solution of which the downlink positioning procedure is backward compatible to the 3GPP standard.

In an embodiment of a client device according to the second aspect, the positioning procedure is an uplink positioning procedure and the reference signal is a sounding reference signal; and the client device is configured to
transmit the sounding reference signal in the uplink according to the second configuration.

An advantage with this embodiment is that it may provide the solution of which the uplink positioning procedure is backward compatible to the 3GPP standard.

In an embodiment of a client device according to the second aspect, the positioning procedure is a downlink positioning procedure and an uplink positioning procedure, and wherein the reference signal is a positioning reference signal in the downlink positioning procedure and a sounding reference signal in the uplink positioning procedure; and wherein the client device is configured to
receive the positioning reference signal in the downlink according to the second configuration, and
transmit the sounding reference signal in the uplink according to the second configuration.

An advantage with this embodiment is that it may provide the solution of which the downlink positioning procedure and the uplink positioning procedure is backward compatible to the 3GPP standard.

In an embodiment of a client device according to the second aspect, the network node is a location management function, and wherein the first message and the second message are LTE positioning protocol messages.

An advantage with this embodiment is that it can provide a compatible solution to the specification in the 3GPP standard for simplified implementation.

According to a third aspect of the present disclosure, the above mentioned and other objectives are achieved with a method for a network node, the method comprising:
determining a geographical position of a client device being configured to perform a positioning procedure according to a first configuration;
determining a set of system parameters associated with the client device based on the geographical position of the client device;
determining a second configuration for the positioning procedure based on the set of system parameters associated with the client device;
transmitting a first message to the client device, the first message comprising an indication to perform the positioning procedure according to the second configuration; and
receiving a second message from the client device, the second message indicating positioning information of the client device according to the second configuration.

The method according to the third aspect can be extended into embodiments corresponding to the embodiments of the network node according to the first aspect. Hence, an embodiment of the method comprises the feature(s) of the corresponding embodiment of the network node.

The advantages of the methods according to the third aspect are the same as those for the corresponding embodiments of the network node according to the first aspect.

According to a fourth aspect of the present disclosure, the above mentioned and other objectives are achieved with a method for a client device comprising:
performing a positioning procedure according to a first configuration;
receiving a first message from a network node, the first message comprising an indication to perform the positioning procedure according to a second configuration;
performing the positioning procedure according to the second configuration to obtain positioning information of the client device; and
transmitting a second message to the network node, the second message indicating the positioning information of the client device according to the second configuration.

The method according to the fourth aspect can be extended into embodiments corresponding to the embodiments of the client device according to the second aspect. Hence, an embodiment of the method comprises the feature(s) of the corresponding embodiment of the client device.

The advantages of the methods according to the fourth aspect are the same as those for the corresponding embodiments of the client device according to the second aspect.

The present disclosure also relates to a computer program, characterized in program code, which when run by at least one processor causes said at least one processor to execute any method according to embodiments of the present disclosure. Further, the present disclosure also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments of the present disclosure will be apparent from the following detailed description.

### BRIEF DESCRIPTION OF THE DRAWINGS

The appended drawings are intended to clarify and explain different embodiments of the present disclosure, in which:

FIG. 1 shows a network node according to an embodiment of the present disclosure;

FIG. 2 shows a method for a network node according to an embodiment of the present disclosure;

FIG. 3 shows a client device according to an embodiment of the present disclosure;

FIG. 4 shows a method for a client device according to an embodiment of the present disclosure;

FIG. 5 shows a communication system according to an embodiment of the present disclosure;

FIG. 6 shows signaling between a network node and a client device according to an embodiment of the present disclosure;

FIG. 7 shows signaling between a network node and a client device for a downlink positioning procedure according to an embodiment of the present disclosure;

FIG. 8 shows signaling between a network node and a client device for an uplink positioning procedure according to an embodiment of the present disclosure; and

FIG. 9 shows signaling between a network node and a client device for a downlink and an uplink positioning procedure according to an embodiment of the present disclosure.

### DETAILED DESCRIPTION

Accurate positioning comes with high cost in terms of overall spectrum usage, network signaling, computational load and power consumption, and is not always needed. For example, in case of vulnerable road user (VRU) application in a dense area, a vehicle needs to slow down significantly and the accurate position of a single VRU becomes irrelevant as such. Also, static defined positioning configurations may result in inefficient positioning and may not reflect the current requirements of a VRU, e.g. VRUs in areas or connected to use cases may need different positioning accuracy, and this accuracy may need to change dynamically. Without the possibility of dynamic configuration, resources may be wasted and the positioning configurations may not reflect the actual VRU requirements. This consideration is not only for VRUs but in general for a user equipment (UE) that requires positioning.

Currently, a location management function (LMF) of the core network configures transmission and reception points (TRPs) with static positioning configurations and on demand positioning configurations are not considered. UE requirements on positioning accuracy might be different depending on the use case scenario and the positioning configurations may therefore not reflect the actual requirements, leading to a non-efficient system use. The same positioning configuration for all the UEs does not reflect the real need of different UEs. In addition, when uplink positioning is used, static configurations for all UEs covered by a TRP may not be efficient in terms of battery consumption. A too accurate positioning may be configured for all UEs although not needed by all of them. This implies that the possibility to adapt the positioning accuracy more dynamically would be beneficial. A dynamic adaptation to the need of a UE with respect to the current use case may be considered. Statically defined positioning configurations may result in inefficient utilization of resources and may not reflect the current requirements of a UE leading to inaccuracy and waste of resources.

An objective of the present disclosure is therefore to provide a mechanism enabling switching between different configuration for a positioning procedure to dynamically adapt the positioning procedure to the current requirements of a UE and/or its environmental conditions. Information elements, signals and indicators may be specified that allows the positioning configurations at the UEs and TRP sides to be dynamically adapted. Furthermore, signals and information elements may be provided in relation to information flow from a location function such as a LMF to a UE for downlink and/or uplink based positioning procedures via e.g. LTE positioning protocol (LPP), LTE positioning protocol A (LPPa), new radio (NR) positioning protocol (NRPP) or NR positioning protocol A (NRPPa).

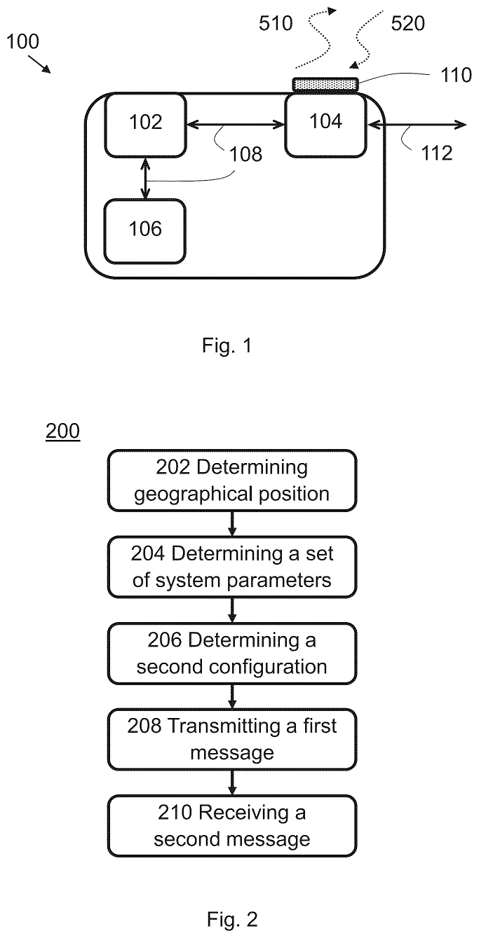

FIG. 1 shows a network node 100 according to an embodiment of the present disclosure. In the embodiment shown in FIG. 1, the network node 100 comprises a processor 102, a transceiver 104 and a memory 106. The processor 102 is coupled to the transceiver 104 and the memory 106 by communication means 108 known in the art. The network node 100 may be configured for both wireless and wired communications in wireless and wired communication systems, respectively. The wireless communication capability is provided with an antenna or antenna array 110 coupled to the transceiver 104, while the wired communication capability is provided with a wired communication interface 112 coupled to the transceiver 104. That the network node 100 is configured to perform certain actions can in this disclosure be understood to mean that the network node 100 comprises suitable means, such as e.g. the processor 102 and the transceiver 104, configured to perform said actions.

The processor 102 of the network node 100 may be referred to as one or more general-purpose CPUs, one or more DSPs, one or more ASICs, one or more FPGAs, one or more programmable logic devices, one or more discrete gates, one or more transistor logic devices, one or more discrete hardware components, and one or more chipsets. The memory 106 of the network node 100 may be a read-only memory, a random access memory, or a NVRAM. The transceiver 104 of the network node 100 may be a transceiver circuit, a power controller, an antenna, or an interface which communicates with other modules or devices. In embodiments, the transceiver 104 of the network node 100 may be a separate chipset or being integrated with the processor 102 in one chipset. While in some embodiments, the processor 102, the transceiver 104, and the memory 106 of the network node 100 are integrated in one chipset.

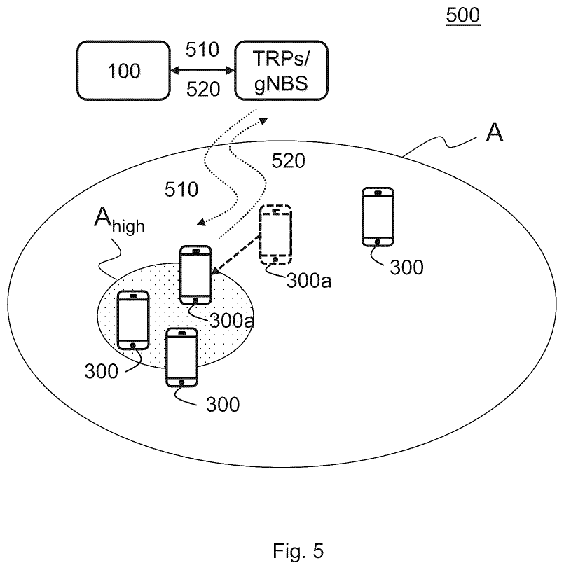

According to embodiments of the present disclosure and with reference to the network node 100 in FIG. 1 and the communication system 500 in FIG. 5, the network node 100 is configured to determine a geographical position of a client device 300 being configured to perform a positioning procedure according to a first configuration and determine a set of system parameters associated with the client device 300 based on the geographical position of the client device 300. The network node 100 is further configured to determine a second configuration for the positioning procedure based on the set of system parameters associated with the client device 300 and transmit a first message 510 to the client device 300. The first message 510 comprises an indication to perform the positioning procedure according to the second configuration. The network node 100 is further configured to receive a second message 520 from the client device 300. The second message 520 indicating positioning information of the client device 300 according to the second configuration.

FIG. 2 shows a flow chart of a corresponding method 200 which may be executed in a network node 100, such as the one shown in FIG. 1. The method 200 comprises determining 202 a geographical position of a client device 300 being configured to perform a positioning procedure according to a first configuration and determining 204 a set of system parameters associated with the client device 300 based on the geographical position of the client device 300. The method 200 comprises determining 206 a second configuration for the positioning procedure based on the set of system parameters associated with the client device 300 and transmitting 208 a first message 510 to the client device 300, the first message 510 comprising an indication to perform the positioning procedure according to the second configuration. The method 200 further comprises receiving 210 a second message 520 from the client device 300, the second message 520 indicating positioning information of the client device 300 according to the second configuration.

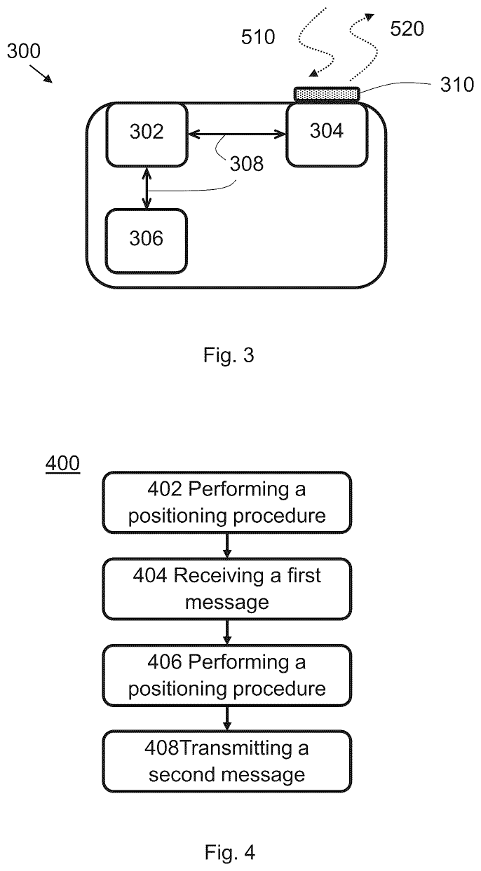

FIG. 3 shows a client device 300 according to an embodiment of the present disclosure. In the embodiment shown in FIG. 3, the client device 300 comprises a processor 302, a transceiver 304 and a memory 306. The processor 302 is coupled to the transceiver 304 and the memory 306 by communication means 308 known in the art. The client device 300 further comprises an antenna or antenna array 310 coupled to the transceiver 304, which means that the client device 300 is configured for wireless communications in a wireless communication system. That the client device 300 is configured to perform certain actions can in this disclosure be understood to mean that the client device 300 comprises suitable means, such as e.g. the processor 302 and the transceiver 304, configured to perform said actions.

The client device 300 in this disclosure includes but is not limited to: a UE such as a smart phone, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, an in-vehicle device, a wearable device, an integrated access and backhaul node (IAB) such as mobile car or equipment installed in a car, a drone, a device-to-device (D2D) device, a wireless camera, a mobile station, an access terminal, an user unit, a wireless communication device, a station of wireless local access network (WLAN), a wireless enabled tablet computer, a laptop-embedded equipment, an universal serial bus (USB) dongle, a wireless customer-premises equipment (CPE), and/or a chipset. In an Internet of things (JOT) scenario, the client device 300 may represent a machine or another device or chipset which performs communication with another wireless device and/or a network equipment.

The UE may further be referred to as a mobile telephone, a cellular telephone, a computer tablet or laptop with wireless capability. The UE in this context may e.g. be portable, pocket-storable, hand-held, computer-comprised, or vehicle-mounted mobile device, enabled to communicate voice and/or data, via the radio access network, with another entity, such as another receiver or a server. The UE can be a station (STA), which is any device that contains an IEEE 802.11-conformant media access control (MAC) and physical layer (PHY) interface to the wireless medium (WM). The UE may also be configured for communication in 3GPP related LTE and LTE-Advanced, in WiMAX and its evolution, and in fifth generation wireless technologies, such as NR.

The processor 302 of the client device 300 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, and one or more chipsets. The memory 306 of the client device 300 may be a read-only memory, a random access memory, or a non-volatile random access memory (NVRAM). The transceiver 304 of the client device 300 may be a transceiver circuit, a power controller, an antenna, or an interface which communicates with other modules or devices. In embodiments, the transceiver 304 of the client device 300 may be a separate chipset or being integrated with the processor 302 in one chipset. While in some embodiments, the processor 302, the transceiver 304, and the memory 306 of the client device 300 are integrated in one chipset.

According to embodiments of the present disclosure and with reference to the client device 300 in FIG. 3 and the communication system 500 in FIG. 5, the client device 300 is configured to perform a positioning procedure according to a first configuration. The client device 300 is further configured to receive a first message 510 from a network node 100, the first message 510 comprising an indication to perform the positioning procedure according to a second configuration. The client device 300 is further configured to perform the positioning procedure according to the second configuration to obtain positioning information of the client device 300. The client device 300 is further configured to transmit a second message 520 to the network node 100, the second message 520 indicating the positioning information of the client device 300 according to the second configuration.

FIG. 4 shows a flow chart of a corresponding method 400 which may be executed in a client device 300, such as the one shown in FIG. 3. The method 400 comprises performing 402 a positioning procedure according to a first configuration. The method 400 comprises receiving 404 a first message 510 from a network node 100, the first message 510 comprising an indication to perform the positioning procedure according to a second configuration. The method 400 comprises performing 406 the positioning procedure according to the second configuration to obtain positioning information of the client device 300. The method 400 comprises transmitting 408 a second message 520 to the network node 100, the second message 520 indicating the positioning information of the client device 300 according to the second configuration.

FIG. 5 shows a communication system 500 according to an embodiment of the present disclosure. The communication system 500 comprises a network node 100 and a number of client devices 300. The network node 100 may be a network node in a core network such as a location management function (LMF) and may communicate with the client devices 300 via one or more transmission reception points (TRPs)/next generation node Bs (gNBs), as indicated in FIG. 5. The TRPs/GNBs cover a geographical area A in which the client devices 300 are located.

The network node 100 have knowledge about the number of client devices 300 in the area A and their positioning requirements. The network node 100 can receive additional information about distribution and density of client devices 300 in the area A, use cases and feedback from the client devices 300. According to embodiments of the present disclosure the network node 100 can based on this information determine configurations for positioning procedures for the client devices 300, either configuration for each client device 300 or configurations per area. The network node 100 may further configure the client devices 300 and TRPs/gNBs with the configurations for positioning procedures and dynamically update the configurations based on current positioning requirements.

In embodiments, the network node 100 may store a table comprising different set of configurations and input parameters and/or thresholds indicating when the configurations should be used. The network node 100 can then select the appropriate configuration from the table depending on situation. For example, in the case of an area with dense presence of client devices 300, configurations for a geographic area rather than for each single client device 300 can be defined. The table may be stored in a data base (not shown).

With reference to FIG. 5, two different areas are defined, a cell area A and a high risk area A_{high} in principle with different characteristics. The high risk area A_{high} may be an area with dense client device concentration where e.g. vehicles have to slow down to avoid collisions, etc. The cell area A may be associated with a first configuration for positioning procedures and the high risk area Ali g n may be associated with a second configuration for positioning procedures. All the client devices 300 in the cell area A may by default be configured with the first configuration, e.g. upon entering the area A and connecting to the network. However, if a client device 300a enters the high risk area Ahi g h, the network node 100 can detect this and inform the client device 300a to change to the second configuration by proper signaling procedures. The network node 100 can therefore inform the client device 300a by transmitting a first message 510 indicating that the second configuration should be used to perform positioning procedures, as shown in FIG. 5 for the particular client device 300a.

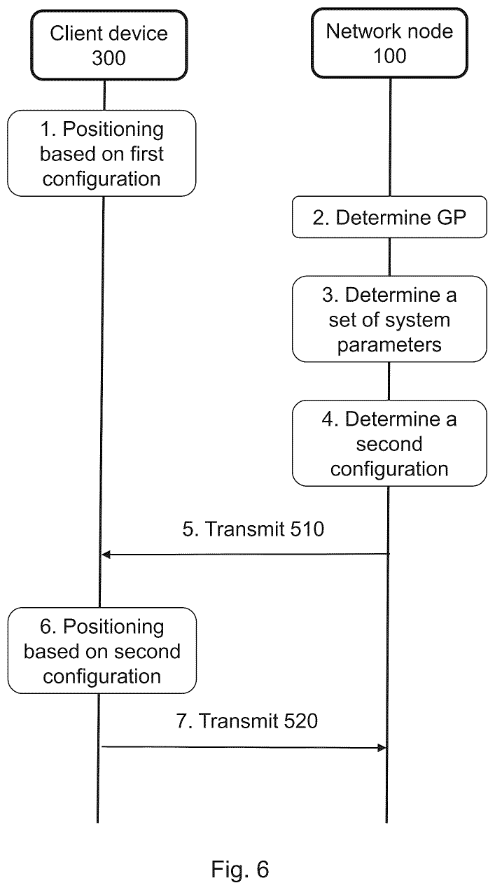

FIG. 6 shows signaling between the network node 100 and a client device 300 for changing a configuration for a positioning procedure according to an embodiment of the present disclosure. The network node 100 may be a LMF and may communicate with the client device 300 via LTE positioning protocol (LPP) messages. Hence, the signaling between the network node 100 and the client device 300 may be performed via one or more intermediate communication nodes, such as network nodes of the core network and network nodes of the radio access network (RAN).

In operation 1 in FIG. 6, the client device 300 performs a positioning procedure according to a first configuration. The positioning procedure is performed by the client device 300 to obtain positioning information of the client deice 300 which may then be shared with the network node 100. In general, the network node 100 is responsible of handling the positioning of connected client devices. When a client device 300 connects to a network the network node 100 configures the client device 300 to perform a positioning procedure according to a first configuration. The signaling of the first configuration from the network node 100 to the client device may be performed according to standardized protocols and interfaces.

In operation 2 in FIG. 6, the network node 100 determines a geographical position GP of the client device 300. The geographical position GP of the client device 300 may be determined based on the positioning information obtained in the positioning procedure according to the first configuration in operation 1. The geographical position GP of the client device 300 may further be determined based on other parameters which may be defined in standards.

In operation 3 in FIG. 6, the network node 100 determines a set of system parameters associated with the client device 300 based on the geographical position GP of the client device 300. The set of system parameters may comprise a client device density of a geographical area GA associated with the geographical position GP and/or a positioning requirement associated with the geographical position GP. The network node 100 may determine the set of system parameters based on information from client devices and/or TRPs/gNBs. For example, if VRUs are considered, the TRP connected to the client device 300 may be connected to a cross-walk and this information may be used to determine the parameters such as use case parameters. Another non-limiting example of information may be a VRU is a bicycle in a dense traffic situation. Such information may be used to determine the parameters, such as the use case parameters and the precise positioning requirements needed.

Based on the determined set of system parameters associated with the client device 300, the network node 100 determines a second configuration for the positioning procedure in operation 4 in FIG. 6. The second configuration may comprise a reference signal indicating a configuration of a periodicity and/or a resource allocation. Depending on the type of positioning procedure the reference signal may be a positioning reference signal and/or a sounding reference signal. When the positioning procedure is a downlink positioning procedure, the reference signal may be a positioning reference signal. When the positioning procedure is an uplink positioning procedure, the reference signal may be a sounding reference signal. Furthermore, when the positioning procedure is a downlink positioning procedure and an uplink positioning procedure, the reference signal may be a positioning reference signal in the downlink positioning procedure and a sounding reference signal in the uplink positioning procedure.

The second configuration may be configured for a client device depending on the geographical position of the client device and mentioned system parameters while the first configuration may be configured for all the client devices within a cell range according to conventional solutions. With such scheme, the second configuration may be indicated with less signaling overhead by only comprising configuration parameters that are different from the first configuration, such as the periodicity and the slot offset of the downlink positioning reference signal and/or the periodicity and the slot offset of the uplink sounding reference signal. e.g., N times less frequent periodicity of DL PRS/UL SRS comparing to the first configuration, which may be applied to a client device. Hence, a delta update mechanism may thereby be provided for signaling the second configuration.

The second configuration determined in operation 4 may hence comprise a positioning reference signal configuration indicating a periodicity and/or a resource allocation of positioning reference signals; and/or a sounding reference signal configuration indicating a periodicity and/or a resource allocation of sounding reference signals. The second configuration may further comprise identities of client devices in a geographical area served by the network node 100, identities of TRPs serving the geographical area served by the network node 100, and reference signal configurations.

In operation 5 in FIG. 6, the network node 100 transmit a first message 510 to the client device 300. The first message 510 comprises an indication to perform the positioning procedure according to the second configuration. In embodiments where the network node 100 is a LMF, the first message 510 may be a LPP message.

The client device 300 receives the first message 510 from a network node 100 and hence the indication to perform the positioning procedure according to a second configuration. Based on the received first message 510, the client device 300 starts to perform the positioning procedure according to the second configuration in operation 6. The positioning procedure according to the second configuration is performed by the client device 300 to obtain positioning information of the client device 300.

As part of the positioning procedure performed in operation 6, the client device 300 may receive a positioning reference signal in the downlink according to the second configuration and/or transmit a sounding reference signal in the uplink according to the second configuration. When the positioning procedure performed is a downlink positioning procedure and the reference signal is a positioning reference signal, the client device 300 may receive the positioning reference signal in the downlink according to the second configuration. When the positioning procedure performed is an uplink positioning procedure and the reference signal is a sounding reference signal, the client device 300 may transmit the sounding reference signal in the uplink according to the second configuration. Furthermore, when the positioning procedure is a downlink positioning procedure and an uplink positioning procedure and the reference signal is a positioning reference signal in the downlink positioning procedure and a sounding reference signal in the uplink positioning procedure, the client device 300 may receive the positioning reference signal in the downlink according to the second configuration and transmit the sounding reference signal in the uplink according to the second configuration.

In operation 7 in FIG. 6, the client device 300 transmits a second message 520 to the network node 100, and the second message 520 indicates the positioning information of the client device 300 obtained in operation 6, i.e. the positioning information obtained using the second configuration. In embodiments where the network node 100 is a LMF, the second message 520 may be a LPP message.

The network node 100 receives the second message 520 from the client device 300 and hence the indicated positioning information of the client device 300 according to the second configuration. The indicated positioning information of the client device 300 may be used by the network node 100 to determine a geographical position GP of the client device 300.

Moreover, in the following disclosure further detailed embodiments of the present disclosure will be presented and described. For providing improved understanding of embodiments of the present disclosure the examples herein presented are set in a 3GPP context hence the terminology, expressions and system architecture used. However, embodiments of the present disclosure are not limited thereto and may be implemented in any suitable communication system.

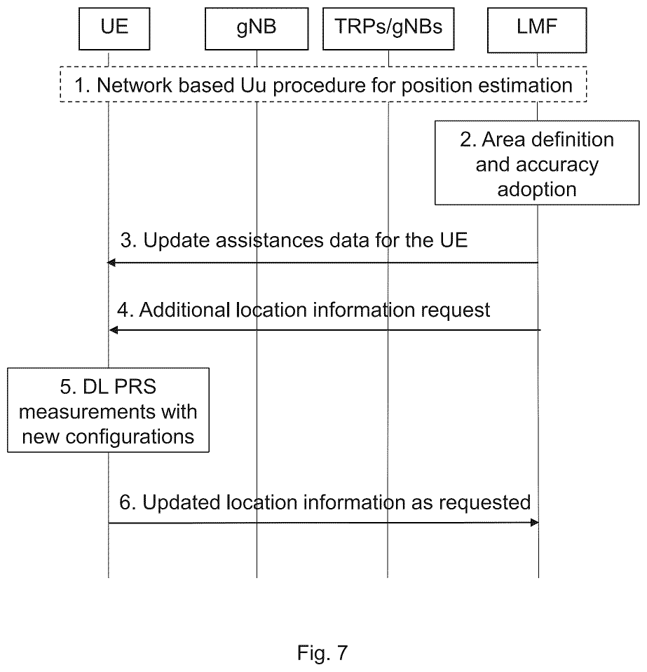

FIG. 7 shows a detailed signaling diagram for a downlink positioning procedure between a UE, TRPs/gNBs of a RAN and a LMF of a core network in a communication system 500, such as 3GPP 5G a.k.a. new radio (NR). Hence, in this example, the client device 300 is a UE, the network node 100 is a LMF, and the first message 510 and the second message 520 are LTE positioning protocol (LPP) messages. The downlink positioning procedure may be a downlink-time difference of arrival (DL-TDoA) procedure, i.e. the downlink positioning may use the difference in time of arrival of signals received at the UE from the TRPs to determine the position of the UE. In this case, TRPs/gNBs are configured from the LMF, targeting areas and/or UEs with a certain positioning reference signal (PRS) granularity.

In operation 1 in FIG. 7, the LMF estimates the position of the UE with a network based Uu procedure for position estimation using a first downlink (DL) PRS configurations. The position estimation may e.g. be performed according to TS 38.305 chapter 8.12.

In operation 2 in FIG. 7, the LMF defines/determines an area in which to dynamically adapt positioning requirements and assigns new DL PRS configurations per UE. The LMF may define the area based on location information of UEs, their density, current position requirements per UE, network load, and/or available resources for existing DL PRS configurations. In addition, since other UEs may be in the same area and therefore have to be configured with the same DL PRS configurations.

Operation 2 in FIG. 7 may include:
The LMF detects that a change of DL PRS configurations is needed.
The LMF determines the area boundaries and which TRPs are serving the area.
The LMF specifies and maintains a list of: UE-IDs in the area, TRP-IDs covering the area, and/or PRS configurations for each TRP-IDs covering the UEs.

In operation 3 in FIG. 7, the LMF via LPP provides updates to existing positioning assistance data for the UE. The update to the existing assistance data may comprise:
Content from the table at LMF, specified in operation 2 previously. A UE for each TRP-ID (also served by the same gNB) can have different DL PRS measurements configurations.
DL PRS configurations for each TRP-IDs involved.

The LMF may dynamically send the parameters of the DL PRS configurations to the UE. Alternatively, the LMF may send a priori a set of DL PRS configurations and then dynamically only the index of the configuration to be used to reduce the amount of messaging. The set of DL PRS configurations may also be preconfigured in the UE which means that only the configuration index has to be signaled.

For the above aspects a new information element may be defined in the LPP message ProvideAssistanceData transmitted in operation 3, ‘UE-specific-NR-DL-PRS-Info’ including the DL PRS periodicity and the slot offset info for each TRP. The new IE ‘UE-specific-NR-DL-PRS-Info may e.g. include a mandatory field: UE-specific-dl-PRS-Periodicity-and-ResourceSetSlotOffset. This periodicity and slot offset field may specify the periodicity of DL PRS allocation in slots configured per DL PRS resource set and the slot offset with respect to system frame number (SFN) slot 0 for a TRP where DL PRS resource set is configured (i.e. slot where the first DL PRS resource of DL PRS resource set occurs) for a UE. If one or more parameters are not included, the parameters of a previously received UE-specific-NR-DL-PRS-Info IE may be used by the UE.

In operation 4 in FIG. 7, the LMF via LPP requests additional location information to keep track of the UE location, path and trajectory. The LMF may request additional information of the measurements from the selected TRP-IDs that have to be reported.

In operation 5 in FIG. 7, the UE performs DL PRS measurements. The UE performs DL PRS measurements based on the PRS configuration received from the LMF in operation 4. The UE may for each TRP-ID perform different measurements according to the received configuration.

In operation 6 in FIG. 7, the UE via LPP provides updated location information as requested for that geographical area. The provided location information may comprise conventional DL TDoA positioning information. If the UE cannot perform measurements for some TRP-IDs signaled in operation 4, the UE may report these TRP-IDs. This information can be used by the LMF to determines if the UE is exiting from the area.

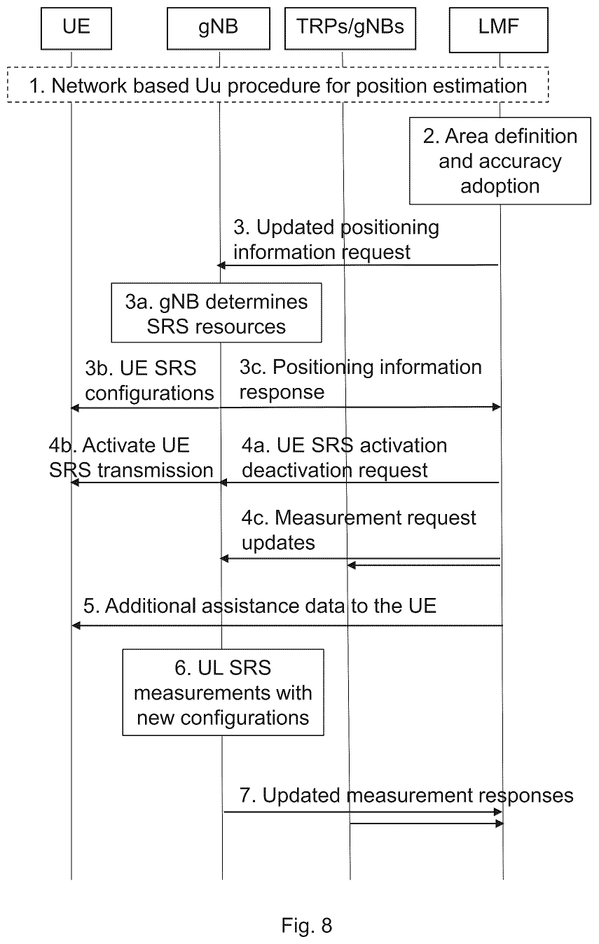

FIG. 8 shows a detailed signaling diagram for an uplink positioning procedure between a UE, TRPs/gNBs of a RAN and a LMF of a core network in a communication system 500, such as 3GPP 5G. The uplink positioning procedure may be an uplink time difference of arrival (UL-TDoA) procedure, i.e. may use the difference in time of arrival of signals received at the TRPs from the UE to determine the UE position. In this case, the LMF configures the UE with sounding reference signals (SRS) messages to be sent for positioning and configures the TRP (gNB) serving the UE to determine the SRS resources.

In operation 1 in FIG. 8, the LMF estimates the position of the UE with a network based Uu procedure for position estimation based on an uplink SRS configuration. The position estimation may be performed according to TS 38.305 chapter 8.13.

In operation 2 in FIG. 8, the LMF determines an area in which to dynamically adapt positioning requirement and assigns new SRS configurations per UE. The LMF may determine the area based on location information of the UE, their density, current position requirements per UE, network load, and/or available resources for existing SRS configurations. In addition, other UEs can be in the same area and hence have to be configured with the same SRS configurations.

Operation 2 in FIG. 8 may include:
The LMF detects that a change of UL SRS configurations is needed.
The LMF defines/determines the area boundaries and which TRPs are serving the area.
The LMF specifies and maintains a list of: UE-IDs in the area, TRP-IDs covering the area, and/or UL SRS configuration for each UE-ID and TRP-IDs (covering the UE).

In operation 3 in FIG. 8, the LMF sends updated positioning information request to a gNB/TRP, for group of UEs. The LMF may transmit a NRPPa message with measurement update to the serving gNB of the UE.

Operation 3 in FIG. 8 may trigger the following actions in the serving gNB:
3a. The gNB determines UL SRS resources for each TRP-ID and each UE-ID.
3b. The gNB configures UL SRS in the UE according to state of art.
3c. The gNB communicates the actual UL-SRS configuration for each TRP-ID to the LMF.

In operation 4 in FIG. 8, the LMF requests activation or deactivation of UE SRS, and the gNB executes the request.
4a. The LMF requests activation and/or deactivation of UE SRS transmission. This may include the LMF transmitting a NRPPa message to the serving gNB with positioning deactivation request for the current UE SRS configuration and transmitting a NRPPa message with positioning activation request for the new UE SRS configuration.
4b. The gNB requests activation and/or deactivation of UE SRS transmission. This may include the serving gNB transmitting a semi persistent (SP) positioning SRS activation/deactivation medium access control (MAC) control element (CE) to the target UE for deactivation of the current SRS transmission and transmitting SP positioning SRS activation/deactivation MAC CE to the target UE for activation of the SRS transmission by using the indicated UL SRS configuration. A 1 bit indication (such as a flag) may be defined in the SP positioning SRS activation/deactivation MAC CE to indicate whether or not to deactivate the old SRS configuration when activating a new SRS configuration. In this way, a single MAC CE could activate a new configuration and deactivate an old configuration simultaneously.
4c. The LMF via NRPPa sends updated measurement requests including the updated SRS configurations to one or more gNBs.

In operation 5 in FIG. 8, the LMF via LPP provides additional assistance data to the UE. The additional assistance data may comprise contents from the table in the LMF (see operation 2) such as TRP-IDs and UL SRS configurations.

In operation 6 in FIG. 8, the gNB performs UL SRS measurements based on the UE SRS transmissions.

In operation 7 in FIG. 8, the gNBs/TRPs provide updated measurement response via NRPPa to the LMF.

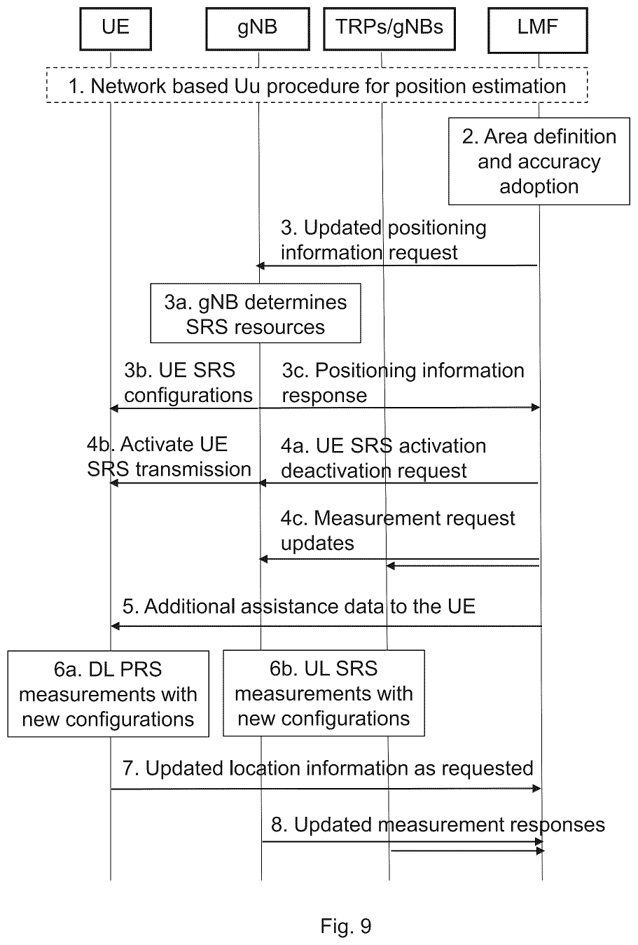

FIG. 9 shows a detailed signaling diagram for a combined downlink and uplink positioning procedure between a UE, TRPs/gNBs of a RAN and a LMF of a core network in a communication system 500, such as 3GPP 5G a.k.a. new radio (NR). The downlink and uplink positioning procedure may be a multi-round trip time (RTT) positioning procedure. The multi-RTT positioning procedure may be based on UE reception-transmission (Rx-Tx) time difference measurements and DL-PRS-reference signal received power (RSRP) of downlink signals received from multiple TRPs by the UE; and the measured gNB Rx-Tx time difference measurements and UL-SRS-RSRP at multiple TRPs of uplink signals transmitted from the UE. The UE measures the UE Rx-Tx time difference measurements (and may measure DL-PRS-RSRP of the received signals) using assistance data received from the LMF, and the TRPs measure the gNB Rx-Tx time difference measurements (and may measure UL-SRS-RSRP of the received signals) using assistance data received from the LMF. The measurements are used to determine the RTT at the LMF which are then used to estimate the location of the UE.

In operation 1 in FIG. 9, the LMF estimates the position of the UE with a network based Uu procedure for position estimation based on a DL PRS and/or an UL SRS configuration. The position estimation may be performed according to TS 38.305 chapter 8.12 and/or 8.13.

In operation 2 in FIG. 9, the LMF defines an area in which to dynamically adapt positioning requirement and assign new PRS/SRS configurations per UE. The LMF may determine the area based on location information of UE, their density, current position requirements per UE, network load, and/or available resources for existing SRS configurations. In addition, other UEs can be in the same area and have to be configured with the same SRS configurations.

Operation 2 in FIG. 9 may include:
The LMF detects that change of configurations is needed.
The LMF determines the area boundaries and which TRPs are serving the area.
The LMF specifies and maintains a list of: UE-IDs in the area, TRP-IDs covering the area, DL PRS configuration for each UE-ID and TRP-IDs (covering the UE), and/or UL SRS configuration for each UE-ID and TRP-IDs (covering the UE).

In operation 3 in FIG. 9, the LMF sends updated positioning information request to a gNB/TRP, for group of UEs. The LMF may transmit a NRPPa message with measurement update to the serving gNB of the UE.

Operation 3 in FIG. 9 may trigger the following actions in the serving gNB:
3a. The gNB determines UL SRS resources for each TRP-ID and each UE-ID.
3b. The gNB configures UL SRS in the UE.
3c. The gNB communicates the actual UL-SRS configuration for each TRP-ID to the LMF

In operation 4 in FIG. 9, the LMF requests activation or deactivation of UE SRS, and the gNB executes the request.
4a. The LMF requests activation and/or deactivation of UE SRS transmission. This may include the LMF transmitting a NRPPa message to the serving gNB with positioning deactivation request for the current UE SRS configuration and transmitting a NRPPa message with positioning activation request for the new UE SRS configuration.
4b. The gNB requests activation and/or deactivation of UE SRS transmission. This may include the serving gNB transmitting SP positioning SRS activation/deactivation MAC CE to the target UE for deactivation of the current SRS transmission and transmitting SP positioning SRS activation/deactivation MAC CE to the target UE for activation of the SRS transmission by using the indicated UL SRS configuration. A 1 bit indication may be defined in the SP positioning SRS activation/deactivation MAC CE to indicate whether or not to deactivate the old SRS configuration when activating a new SRS configuration. In this way, a single MAC CE could activate a new configuration and deactivate an old configuration simultaneously.
4c. The LMF via NRPPa sends updated measurement requests including the updated SRS configurations to one or more gNBs.

In operation 5 in FIG. 9, the LMF via LPP provides additional assistance data to the UE. The additional assistance data may comprise contents from the table in the LMF (see operation 2) such as DL PRS configuration and UL SRS configurations for each TRP-ID involved.

In operation 6 in FIG. 9, positioning measurement are performed by the UE and the gNBs/TRPs. In operation 6a, the UE performs DL PRS measurements based on the received additional assistance data. For each TRP-ID the UE perform different measurements according to the PRS configurations provided by the LMF. In operation 6b, the gNBs/TRPs performs UL SRS measurements based on the UE SRS transmissions from the UE.

In operation 7 in FIG. 9, the UE provides updated location information as requested for that geographical area via LPP to the LMF.

In operation 8 in FIG. 9, the gNBs/TRPs provide updated measurement response via NRPPa to the LMF.

The network node 100 may be denoted a LMF as defined by the 3GPP standard. The LMF may be a function configured for communication in 3GPP fifth generation wireless technologies, such as NR.

The client device 300 herein, may be denoted as a user device, a UE, a mobile station, an internet of things (IoT) device, a sensor device, a wireless terminal and/or a mobile terminal, is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM). The UE may also be configured for communication in 3GPP related LTE and LTE-Advanced, in WiMAX and its evolution, and in fifth generation wireless technologies, such as New Radio.

Furthermore, any method according to embodiments of the present disclosure may be implemented in a computer program, having code means, which when run by processing means causes the processing means to execute the operations of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the network node 100 and the client device 300 comprises the communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Especially, the processor(s) of the network node 100 and the client device 300 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present disclosure is not limited to the embodiments described above, but also relates to and incorporates all embodiments within the scope of the appended independent claims.

1. A network node for a communication system, the network node configured to:
determine a geographical position of a client device configured to perform a positioning procedure according to a first configuration;
determine a set of system parameters associated with the client device based on the geographical position of the client device;
determine a second configuration for the positioning procedure based on the set of system parameters associated with the client device;
transmit a first message to the client device, the first message comprising an indication to perform the positioning procedure according to the second configuration; and
receive a second message from the client device, the second message indicating positioning information of the client device according to the second configuration.

2. The network node according to claim 1, wherein the set of system parameters comprise a client device density of a geographical area associated with the geographical position and/or a positioning requirement associated with the geographical position.

3. The network node according to claim 1, wherein the second configuration comprises a reference signal indicating a configuration of a periodicity and/or a resource allocation.

4. The network node according to claim 3, wherein the positioning procedure is a downlink positioning procedure and the reference signal is a positioning reference signal.

5. The network node according to claim 3, wherein the positioning procedure is an uplink positioning procedure and the reference signal is a sounding reference signal.

6. The network node according to claim 3, wherein the positioning procedure is a downlink positioning procedure and an uplink positioning procedure, and wherein the reference signal is a positioning reference signal in the downlink positioning procedure and a sounding reference signal in the uplink positioning procedure.

7. The network node according to claim 1, wherein the network node is a location management function, and wherein the first message and the second message are LTE positioning protocol messages.

8. A client device for a communication system, the client device configured to:
perform a positioning procedure according to a first configuration;
receive a first message from a network node, the first message comprising an indication to perform the positioning procedure according to a second configuration;
perform the positioning procedure according to the second configuration to obtain positioning information of the client device; and
transmit a second message to the network node, the second message indicating the positioning information of the client device according to the second configuration.

9. The client device according to claim 8, wherein the second configuration comprises a reference signal indicating a configuration of a periodicity and/or a resource allocation.

10. The client device according to claim 9, wherein the positioning procedure is a downlink positioning procedure and the reference signal is a positioning reference signal, the client device configured to:
receive the positioning reference signal in the downlink according to the second configuration.

11. The client device according to claim 9, wherein the positioning procedure is an uplink positioning procedure and the reference signal is a sounding reference signal, the client device configured to:
transmit the sounding reference signal in the uplink according to the second configuration.

12. The client device according to claim 9, wherein the positioning procedure is a downlink positioning procedure and an uplink positioning procedure, and wherein the reference signal is a positioning reference signal in the downlink positioning procedure and a sounding reference signal in the uplink positioning procedure, the client device configured to:
receive the positioning reference signal in the downlink according to the second configuration, and
transmit the sounding reference signal in the uplink according to the second configuration.

13. The client device according to claim 8, wherein the network node is a location management function, and wherein the first message and the second message are LTE positioning protocol messages.

14. A method for a client device, the method comprising:
performing a positioning procedure according to a first configuration;
receiving a first message from a network node, the first message comprising an indication to perform the positioning procedure according to a second configuration;
performing the positioning procedure according to the second configuration to obtain positioning information of the client device; and
transmitting a second message to the network node, the second message indicating the positioning information of the client device according to the second configuration.

15. The method according to claim 14, wherein the second configuration comprises a reference signal indicating a configuration of a periodicity and/or a resource allocation.

16. The method according to claim 15, wherein the positioning procedure is a downlink positioning procedure and the reference signal is a positioning reference signal, the method further comprising:
receiving the positioning reference signal in the downlink according to the second configuration.

17. The method according to claim 15, wherein the positioning procedure is an uplink positioning procedure and the reference signal is a sounding reference signal, the method further comprising:
transmitting the sounding reference signal in the uplink according to the second configuration.

18. The method according to claim 15, wherein the positioning procedure is a downlink positioning procedure and an uplink positioning procedure, and wherein the reference signal is a positioning reference signal in the downlink positioning procedure and a sounding reference signal in the uplink positioning procedure, the method further comprising:
receiving the positioning reference signal in the downlink according to the second configuration; and
transmitting the sounding reference signal in the uplink according to the second configuration.

19. The method according to claim 14, wherein the network node is a location management function, and wherein the first message and the second message are LTE positioning protocol messages.
